(19) United States
(12) Patent Application Publication
(10) Pub. No.: US 2002/0159042 A1
(43) Pub. Date: Oct. 31, 2002

(54) Chamber assembly for an exposure apparatus

(76) Inventor: Alex Ka Tim Poon, San Ramon, CA (US)

Correspondence Address: STEVEN G. ROEDER, THE LAW OFFICE OF STEVEN G. ROEDER, 5560 Chelsea Avenue, La Jolla, CA, 92037, US

(21) Appl. No.: 09/842,744

(22) Filed: Apr. 25, 2001

(51) Int. Cl. G03B 27/42

(52) U.S. Cl. 355/53; 355/30; 356/237.2

(57) ABSTRACT

An exposure apparatus (10) that transfers an image to a device (32) includes a stage (60) that retains the device (32) and a chamber assembly (12). The chamber assembly (12) encircles the device (32) and is used with an environmental system (26) to provide a controlled environment around the device (32). The chamber assembly (12) includes at least one fixed section (34), at least one moving section (36), and a seal assembly (38). The moving section (36) moves relative to the fixed section (34). The seal assembly (38) seals an intersection between the fixed section (34) and the moving section (36) during movement of the moving section (36). Moreover, the moving section (36) is secured to the stage (60) and moves concurrently with the stage (60). The chamber assembly (12) facilitates faster pump-outs of the chamber and enhances the access to the components of the exposure apparatus (10) to allow for field servicing and trouble shooting of the components. Moreover, the components that generate dust and debris are positioned outside the chamber assembly (12) and do not contaminate the controlled environment.

### FIELD OF THE INVENTION

The present invention is directed to an exposure apparatus. More specifically, the present invention is directed to a chamber assembly and method for creating a controlled environment for an exposure apparatus that facilitates faster pump-outs of the chamber and enhances the access to the components of the exposure apparatus to allow for field servicing and trouble shooting of the components.

### BACKGROUND

Exposure apparatuses are commonly used to transfer images from a reticle onto a semiconductor wafer during semiconductor processing. A typical exposure apparatus includes an apparatus frame, a measurement system, a control system, an illumination source, a projection optical assembly, a reticle stage assembly for retaining the reticle, and a wafer stage assembly for retaining the semiconductor wafer.

The illumination source generates a beam of light energy that passes through the reticle. The projection optical assembly directs and/or focuses the light passing through the reticle to the wafer. The wafer stage assembly includes a wafer stage and one or more motors that precisely position the wafer relative to the projection optical assembly. Similarly, the reticle stage assembly includes a reticle stage and one or more motors to precisely position the reticle relative to the projection optical assembly.

Depending upon the type of light energy generated by the illumination source, the type of fluid between the illumination source and the wafer can greatly influence the performance of the exposure apparatus. Typically, an exposure apparatus includes air between the illumination source and the wafer. As is well known, air is a gaseous mixture that is approximately twenty-one percent oxygen. Some types of light energy are absorbed by oxygen. Air also includes water vapor, carbon dioxide and other hydrocarbons, which also absorb significant amounts of the light energy. Even trace amounts of these unwanted fluids, i.e. ten parts per million or less, can result in absorption of the light energy. Absorption of the light energy can lead to losses of intensity and uniformity of the light energy. Moreover, absorption of the light energy can lead to localized heating. Thus, the performance of the exposure apparatus and the quality of the integrated circuits formed on the wafer can be enhanced by controlling the environment around one or both stages.

One way to control the environment around a stage is to position a chamber around the stage. Subsequently, the desired environment can be created within the chamber around the stage. Unfortunately, existing chambers are relatively large. As a result thereof, creating the desired environment in the chamber takes a significant amount of time. This reduces the throughput of the exposure apparatus. Further, existing chambers prohibit access to some of the components of the exposure apparatus and inhibit field servicing, adjusting, and trouble shooting of the exposure apparatus. For example, existing chambers have to be opened for maintaining, adjusting, servicing and trouble shooting of the motors of the stage assembly. Anytime the chamber is opened and the inside exposed to the outside world, it will be necessary to reestablish the controlled environment again by purging, pump out, or other actions. Additionally, in some cases, the performance of the components will be different in air compared to the controlled environment in which the components are designed for. Thus, it is very difficult to troubleshoot a problem with a component in this manner. Moreover, the motors create dust and other contaminants that can adversely influence the controlled environment.

In light of the above, a need exists for an exposure apparatus that is capable of generating high-resolution patterns on a semiconductor wafer. Another need exists for a chamber assembly that minimizes the amount of time and replacement fluid necessary to create a controlled environment around a stage. Additionally, the need exists for a chamber assembly that provides easy access to the motors of the stage assembly without opening the chamber.

### SUMMARY

The present invention is directed to an exposure apparatus for transferring an image onto a device. The exposure apparatus includes a stage and a chamber assembly. The chamber assembly encircles the device and is used with an environmental system to provide a controlled environment around the device. As provided herein, the chamber assembly includes at least one fixed section, at least one moving section, and a seal assembly. The moving section moves relative to the fixed section and the seal assembly seals an intersection between the fixed section and the moving section during movement of the moving section.

In one embodiment, the moving section is secured to the stage and moves concurrently with the stage. With this design, a smaller chamber assembly can be used to encircle the device and a stage mover assembly that moves the stage can be positioned outside the chamber assembly.

Typically, the exposure apparatus includes a stage mover assembly having one or more movers that move the stage and the device. Preferably, the stage mover assembly is positioned outside the device chamber. This enhances the access to the movers of the stage mover assembly to allow for field servicing, maintaining, and trouble shooting of the movers without opening the chamber assembly and without disrupting the controlled environment. Moreover, the dust and debris generated by the movers does not contaminate the controlled environment.

In an embodiment of the present invention, the fixed section includes a top wall and four side walls and the moving section includes a bottom wall. The top wall, the side walls and the bottom wall cooperate to define a substantially rectangular shaped housing. In this embodiment, the seal assembly seals a bottom edge of the side walls to a top surface of the bottom wall.

Importantly, the reduced chamber size and ability to service without comprising the controlled environment should reduce down-time and increase throughput of the exposure apparatus.

The present invention is also directed to a device, a wafer, a method for making a chamber assembly, a method for making an exposure apparatus, a method for making a device, and a method for manufacturing a wafer.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a front plan illustration of an exposure apparatus having features of the present invention, with a chamber assembly and a first chamber partly cut-away;

FIG. 2 is an exploded perspective view of a chamber assembly having features of the present invention;

FIG. 3 is a flow chart that outlines a process for manufacturing a semiconductor wafer in accordance with the present invention; and

FIG. 4 is a flow chart that outlines semiconductor wafer processing in more detail.

### DESCRIPTION

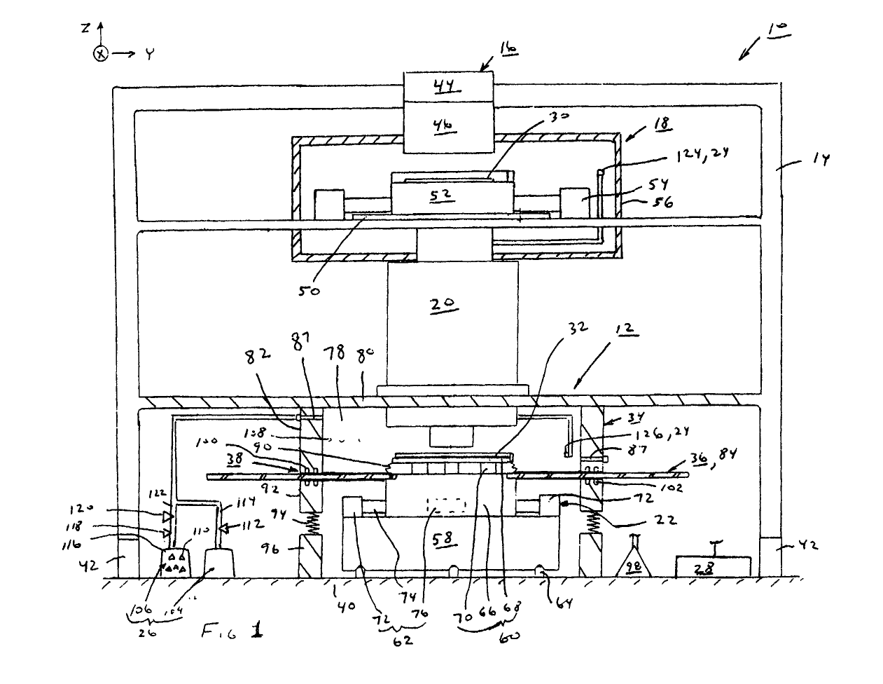

FIG. 1 is a simplified illustration of an exposure apparatus 10 including a chamber assembly 12 having features of the present invention. In addition to the chamber assembly 12, the exposure apparatus 10 includes (i) an apparatus frame 14, (ii) an illumination system 16 (irradiation device), (iii) a first stage assembly 18, (iv) a projection optical assembly 20, (v) a second stage assembly 22, (iii) a measurement assembly 24, (vi) an environmental system 26, and (vii) a control system 28. The exposure apparatus 10 is particularly useful as a lithographic device that transfers a pattern (not shown) of an integrated circuit from a reticle 30 onto a device 32 such as a semiconductor wafer.

There are a number of different types of lithographic devices. For example, the exposure apparatus 10 can be used as scanning type photolithography system that exposes the pattern from the reticle 30 onto the wafer 32 with the reticle 30 and wafer 32 moving synchronously. In a scanning type lithographic device, the reticle 30 is moved perpendicular to an optical axis of the projection optical assembly 20 by the first stage assembly 18, and the wafer 32 is moved perpendicular to the optical axis of the projection optical assembly 20 by the second stage assembly 22. Scanning of the reticle 30 and the wafer 32 occurs while the reticle 30 and the wafer 32 are moving synchronously.

Alternately, the exposure apparatus 10 can be a step-and-repeat type photolithography system that exposes the reticle 30 while the reticle 30 and the wafer 32 are stationary. In the step and repeat process, the wafer 32 is in a constant position relative to the reticle 30 and the projection optical assembly 20 during the exposure of an individual field. Subsequently, between consecutive exposure steps, the second stage assembly 22 consecutively moves the wafer 32 perpendicular to the optical axis of the projection optical assembly 20 so that the next field of the wafer 32 is brought into position relative to the projection optical assembly 20 and the reticle 30 for exposure. Following this process, the images on the reticle 30 are sequentially exposed onto the fields of the wafer 32 so that the next field of the wafer 32 is brought into position relative to the projection optical assembly 20 and the reticle 30.

The present invention is likely to be most useful when the irradiation consists of charged particles, such as electrons or ions. However, the present invention can also be useful in photolithography systems where the irradiation consists of photons of any wavelength.

Some of the Figures provided herein include a coordinate system that designates an X axis, a Y axis, and a Z axis. It should be understood that the coordinate system is merely for reference and can be varied. For example, the X axis can be switched with the Y axis and/or the exposure apparatus 10 can be rotated.

As provided herein, the chamber assembly 12 encircles the device 32 and is used with the environmental system 26 to provide a controlled environment around the device 32. As an overview, the chamber assembly 12 includes at least one fixed section 34, at least one moving section 36, and a seal assembly 38. The moving section 36 moves relative to the fixed section 34. The seal assembly 38 seals an intersection between the fixed section 34 and the moving section 36 during movement of the moving section 36. As a result of this design, the moving section 36 can be secured to a portion of the second stage assembly 22 and can move concurrently with a portion of the second stage assembly 22.

With this design, a smaller chamber assembly 12 can be used to encircle the device 32 and some of the components of the second stage assembly 22 are positioned outside the chamber assembly 12. The smaller chamber assembly 12 facilitates faster pump-outs of the chamber and enhances the access to the components of the exposure apparatus 10 to allow for field servicing, maintaining, and trouble shooting of the components. Moreover, the components of the second stage assembly 22 that generate dust and debris are positioned outside the chamber and do not contaminate the controlled environment.

The apparatus frame 14 illustrated in the FIG. 1 supports some of the assemblies of the exposure apparatus 10 above a mounting base 40. The design of the apparatus frame 14 can be varied to suit the design requirements for the rest of the exposure apparatus 10. In the embodiment illustrated in FIG. 1, the apparatus frame 14 is rigid and supports the first stage assembly 18, the illumination system 16, the projection optical assembly 20, the chamber assembly 12 and the measurement system 24 above the mounting base 40. Alternately, separate frames (not shown) can be used to support one or more of the assemblies. For example, the projection optical assembly 20 and the measurement system 24 can be supported independently from the illumination system 16, the first stage assembly 18 and the chamber assembly 12.

Preferably, the apparatus frame 14 is secured to the mounting base 40 with one or more frame isolators 42. In this embodiment, the mounting base 40 is illustrated as a flat structure. The mounting base 40 can be the ground, a base, or floor or some other supporting structure. The frame isolators 42 reduce the effect of vibration of the mounting base 40 causing vibration on the apparatus frame 14. The design, number and location of the frame isolators 42 can be varied. As provided herein, each frame isolator 42 can include a pneumatic cylinder (not shown) that isolates vibration and an actuator (not shown) that isolates vibration and controls the position with at least two degrees of motion. Suitable frame isolators 42 are sold by Integrated Dynamics Engineering, located in Woburn, Mass.

The illumination system 16 includes an illumination source 44 (illustrated as a block) and an illumination optical assembly 46 (illustrated as a block). The illumination source 44 emits a beam (irradiation) of light energy. The illumination source 44 can be g-line (436 nm), i-line (365 nm), KrF excimer laser (248 nm), ArF excimer laser (193 nm), and F₂ laser (157 nm). Alternately, the illumination source 44 can use charged particle beams such as an x-ray and electron beam. For instance, in the case where an electron beam is used, thermionic emission type lanthanum hexaboride (LaB₆) or tantalum (Ta) can be used as an electron gun. Furthermore, in the case where an electron beam is used, the structure could be such that either a mask is used or a pattern can be directly formed on a substrate without the use of a mask. In the embodiment in FIG. 1, the illumination source 44 is illustrated as being positioned above the illumination optical assembly 46. The illumination optical assembly 46 guides the irradiation from the illumination source 44 to above the first stage assembly 18.

The first stage assembly 18 holds and positions the reticle 30 relative to the projection optical assembly 20 and the device 32. The design of the first stage assembly 18 and the components of the first stage assembly 18 can be varied to suit the design requirements of the exposure apparatus 10. In the embodiment illustrated in FIG. 1, the first stage assembly 18 includes a first stage base 50, a first stage 52, a first stage mover assembly 54 (illustrated as a pair of blocks) and a first container 56.

The first stage base 50 guides and supports the first stage 52. Typically, the first stage base 50 is a generally flat plate that includes an opening (not shown) that allows the energy beam (not shown) to pass from the reticle 30 to the projection optical assembly 26. The first stage 52 retains the reticle 30. As provided herein, a vacuum preload type, fluid bearing can be used to support the first stage 52 above the first stage base 50 and allow for motion of the first stage 52 along the X axis, along the Y axis and about the Z axis relative to the first stage base 50. Alternately, the first stage 52 can be supported spaced apart from the first stage base 50 by other ways. For example, a magnetic type bearing or roller type bearing could be utilized that allows for motion of the first stage 52 relative to the first stage base 50.

The first stage mover assembly 54 moves and positions the first stage 52 relative to the first stage base 50 and the rest of the exposure apparatus 10. The design of the first stage mover assembly 54 can be varied. For example, the first stage mover assembly 54 can include one or more rotary motors, voice coil motors, linear motors, electromagnetic actuators, and/or some other type of force actuators. Preferably, the first stage mover assembly 54 moves and positions the first stage 52 along the X axis, along the Y axis and about the Z axis under the control of the control system 28. Even more preferably, the first stage mover assembly 54 could be designed to move the first stage 52 relative to the first stage base 50 along the X axis, along the Y axis, along the Z axis, about the X axis, about the Y axis and/or about the Z axis.

The first container 56 encircles and encloses the reticle 30 and is used to provide a controlled environment around the reticle 30. The type of controlled environment, for example, can be a vacuum, or an inert gas. The first container 56 can be sealed to the illumination optical assembly 46 and the projection optical assembly 20 with mechanical bellows (not shown). In this embodiment, the first container 56 is generally box shaped and is secured directly to the illumination optical assembly 46 and the first stage assembly 18. It should be noted that the first container 56 is an optional component of the exposure apparatus 10. Further, the first container 56 can be designed somewhat similar to the chamber assembly 12 described below.

The projection optical assembly 20 projects and/or focuses the irradiation passing through reticle 30 to the wafer 32. Depending upon the design of the exposure apparatus 10, the projection optical assembly 20 can magnify or reduce the image created at the reticle. Alternately, the projection optical assembly 20 can be a 1× or magnification system. With respect to the projection optical assembly 20, when far ultra-violet rays such as the excimer laser is used, glass materials such as quartz and fluorite that transmit far ultra-violet rays is preferable to be used. When the F₂ type laser or x-ray is used, the projection optical assembly 20 should preferably be either catadioptric or refractive (a reticle should also preferably be a reflective type), and when an electron beam is used, electron optics should preferably consist of electron lenses and deflectors. The optical path for the electron beams should be in a vacuum.

The second stage assembly 22 holds and positions the device 32 with respect to the projected image of the illuminated portions of the reticle 30. The design of the second stage assembly 22 and the components of the second stage assembly 22 can be varied to suit the design requirements of the exposure apparatus 10. In the embodiment illustrated in FIG. 1, the second stage assembly 22 includes a second stage base 58, a second stage 60, and a second stage mover assembly 62.

The second stage base 58 guides and supports the second stage 60. Typically, the second stage base 58 is a generally flat plate. In the embodiment illustrated in the FIG. 1, three spaced apart base mounts isolators 64 that kinematically secure the second stage base 58 to the mounting base 40. The base mount isolators 64 inhibit vibration of the mounting base 40 causing vibration to the second stage 60. As provided herein, each base mount isolator 64 can include a pneumatic cylinder (not shown) that isolates vibration and an actuator (not shown) that isolates vibration and controls the position with at least two degrees of motion. Suitable base mount isolators 64 are sold by Integrated Dynamics Engineering, located in Woburn, Mass.

The second stage 60 retains the wafer 32. The design of the second stage 60 can vary according to the movement requirements of the wafer 32. In the embodiment illustrated in FIG. 1, the second stage 60 includes a lower stage frame 66, a device table 68 and a table mover assembly 70 (illustrated as three blocks). Alternately, for example, the device table 68 and the lower stage frame 66 could be formed as a single unit.

Typically, a vacuum preload type, fluid bearing supports the lower stage frame 66 above the second stage base 58 and allows for motion of the second stage 60 along the X axis, the Y axis and about the Z axis relative to the second stage base 58. Alternately, the lower stage frame 66 can be supported spaced apart from the second stage base 58 by other ways. For example, a magnetic type bearing or roller type bearing could be utilized that allows for motion of the second stage 60 relative to the second stage base 58.

The device table 68 includes a device holder (not shown) such as a chuck or clamp that retains the device 32. The table mover assembly 70 moves and positions the device table 68 relative to the lower stage frame 66 and the rest of the exposure apparatus 10. The design of the table mover assembly 70 can be varied. For example, the table mover assembly 70 can include one or more rotary motors, voice coil motors, linear motors, electromagnetic actuators, and/or some other type of force actuators. Preferably, the table mover assembly 70 moves and positions the device table 68 along the Z axis, about the X axis and about the Y axis under the control of the control system 28 relative to the lower stage frame 66 and the rest of the exposure apparatus 10. Even more preferably, the table mover assembly 70 could be designed to move the device table 68 relative to the lower stage frame 66 along the X axis, along the Y axis, along the Z axis, about the X axis, about the Y axis, and about the Z axis.

The second stage mover assembly 62 moves and positions the lower stage frame 66 of the second stage 60 relative to the second stage base 58 and the rest of the exposure apparatus 10. The design of the second stage mover assembly 62 can be varied. For example, the second stage mover assembly 62 can include one or more rotary motors, voice coil motors, linear motors, electromagnetic actuators, and/or some other type of force actuators.

In the embodiment illustrated in FIG. 1, the second stage mover assembly 62 includes two spaced apart X movers 72 (illustrates as blocks), a guide bar 74, and a Y mover 76 (illustrated as a phantom block). In this embodiment, the X movers 72 move the guide bar 74 and the lower stage frame 66 along the X axis and about the Z axis, and the Y mover 76 moves the lower stage frame 66 relative to the guide bar 74 along the Y axis. With this design, the second stage mover assembly 62 moves and positions the lower stage frame 66 of the second stage 60 along the X axis, along the Y axis and about the Z axis under the control of the control system 28. Alternately, for example, the second stage mover assembly 62 could be designed to move the second stage 60 relative to the second stage base 58 along the X axis, along the Y axis, along the Z axis, about the X axis, about the Y axis and/or about the Z axis.

Preferably, the components of the second stage mover assembly 62 that generate dust and debris are positioned outside the chamber assembly 12. For example, as illustrated in FIG. 1, the X movers 72, the guide bar 74 and the Y mover 76 are positioned outside the chamber assembly 12. With this design, the controlled environment around the wafer 32 is not subjected to the dust and debris from the X movers 72, the guide bar 74 and the Y mover 76. Further, the X movers 72, the guide bar 74 and the Y mover 76 are exposed and accessible for adjustment, servicing and maintenance without compromising the controlled environment around the device 32.

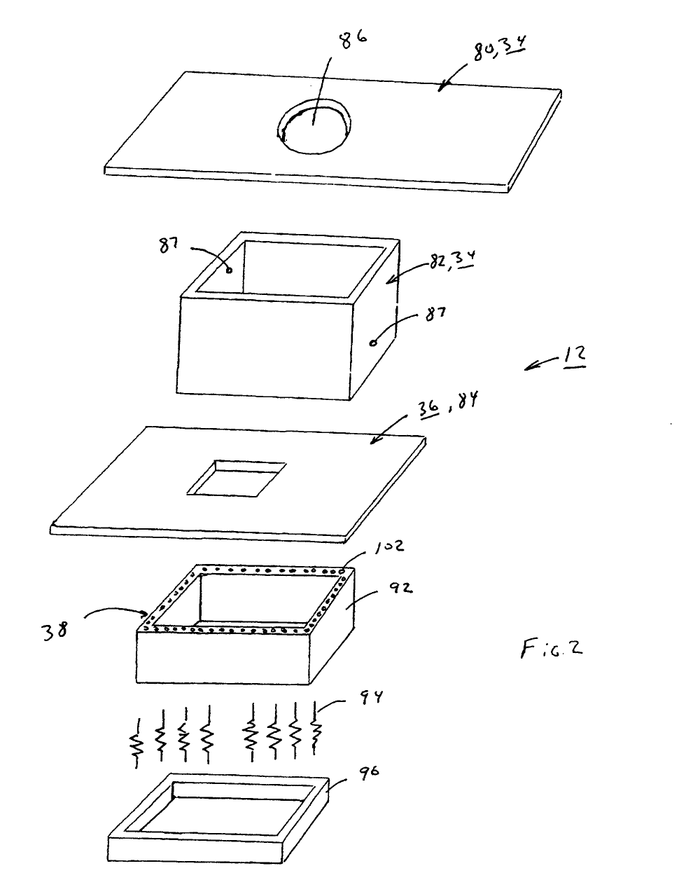

The chamber assembly 12 encircles the device 32 and is used with the environmental system 26 to provide a controlled environment around the device 32. As provided herein, the chamber assembly 12 defines a device chamber 78 and includes the fixed section 34, the moving section 36, and the seal assembly 38. The design of the components of the chamber assembly 12 can vary in size and shape according to the design of the exposure apparatus 10. In the embodiment illustrated in FIGS. 1 and 2, the chamber assembly 12 includes (i) a top wall 80, (ii) four side walls 82 that extend perpendicularly downward from the top wall 80, the four side walls 82 forming a rectangular frame shape, and (iii) a bottom wall 84 that is spaced apart and substantially parallel with the top wall 80. In the embodiment illustrated in the Figures, the top wall 80 and the side walls 82 define the fixed sections 34 and the bottom wall 84 defines the moving section 36 that moves relative to the fixed sections 34.

Referring to FIGS. 1 and 2, the top wall 80 is secured to the apparatus frame 14 and includes a lens aperture 86 for receiving the projection optical assembly 20 and securing the projection optical assembly 20 to the apparatus frame 14. Preferably, the chamber assembly 12 includes one or more chamber ports 87 which provide access to the device chamber 78. In FIG. 1, two chamber ports 87 extend through the side walls 82.

The bottom wall 84 is attached to the second stage 60 and moves with the second stage 60. More specifically, the bottom wall 84 includes a stage aperture 88 for receiving a portion of the second stage 60 and securing the bottom wall 84 to the second stage 60. In the embodiment illustrated in the Figures, the bottom wall 84 is fixedly supported, secured and sealed to the lower stage frame 66 and moves with the lower stage frame 66 relative to the rest of the exposure apparatus 10. With this design, the bottom wall 84 cooperates with the lower stage frame 66 to separate the device 32 from and the second stage mover assembly 62. As a result of this design, the device chamber 78 is smaller, the movers 72, 76 are exposed for service and debris from the movers 72, 76 does contaminate the controlled environment.

Moreover, with this design, the table mover assembly 70 can adjust the position of the device table 68 and device 32 relative to the bottom wall 84 and the rest of the exposure apparatus 10. Preferably, the chamber assembly 12 includes a table seal 90 that flexibly seals the device table 68 to the bottom wall 84. The table seal 90 isolates dust and debris from the table mover assembly 70 from the controlled environment. The design of the table seal 90 can be varied. For example, a flexible bellow can be used as the table seal 90.

Each of the walls 80, 82, 84 is preferably rigid and is constructed from materials such as metal or plastic. The required thickness and strength of the walls 80, 82, 84 will depend upon type of controlled environment. For example, thicker and stronger walls 80, 82, 84 are necessary if the controlled environment is a vacuum.

The seal assembly 38 seals an intersection between the fixed section 34 and the moving section 36 and allows for movement of the moving section 36. As a result of this design, the moving section 36 can be secured to a portion of the second stage assembly 22 and can move concurrently with a portion of the second stage assembly 22. The design of the seal assembly 38 can vary according to the design of the rest of the chamber assembly 12 and the controlled environment.

In the embodiment illustrated in the Figures, a top surface of the moving bottom wall 84 is positioned in close proximity to a bottom edge of the side walls 82 and the bottom wall 84 is maintained a small distance from the side walls 82 with an opposed pair of fluid bearings. The close proximity of the bottom wall 84 to the bottom edge of the side walls 82 inhibits leakage to and/or from the controlled environment.

More specifically, in this embodiment, the seal assembly 38 includes a seal frame 92, a resilient support 94, a frame base 96 and a bearing fluid source 98. The seal frame 92 and the frame base 96 are each rectangular frame shaped. The resilient support 94 is positioned between the seal frame 92 and the frame base 96 and urges the seal frame 92 upwards towards a bottom surface of the bottom wall 84. Stated another way, the resilient support 94 preloads the seal frame 92 towards the bottom wall 84 and compensates for irregularities in flatness of the bottom wall 84. The resilient support 94 can include one or more spaced apart springs, actuators, and/or pneumatic cylinders.

As provided herein, the bottom edge of each of the side walls 82 includes a plurality of spaced apart side fluid outlets 100. Similarly, the top edge of seal frame 92 includes a plurality of spaced apart frame fluid outlets 102. The bearing fluid source 98 directs pressurized fluid from (i) the side fluid outlets 100 towards the top surface of the bottom wall 84 and (ii) the frame fluid outlets 102 towards the bottom surface of the bottom wall 84 to create the opposed pair fluid bearings. The opposed fluid bearings maintain the bottom wall 84 spaced apart slightly from the side walls 82 and the seal frame 92 along the Z axis and allows for motion of the bottom wall 84 along the X axis, the Y axis and about the Z axis relative to the side walls 82 and the seal frame 92.

Each of the fluid outlets 100, 102 can include multiple grooves, they are for gas and/or vacuum at possible different pressures. The configuration of the fluid outlets 100, 102 will depend on the type of controlled environment.

Alternately, the seal assembly 38 could have another design. For example, the moving bottom wall 84 could be maintained in close proximity to the bottom edge of the side walls 82 with a vacuum type fluid bearing. In this embodiment, the seal frame, the resilient support, and the frame base are not necessary. Instead, the bottom edge of the side walls 82 includes a plurality of spaced apart fluid outlets and a plurality of spaced apart fluid inlets. Pressurized fluid is released from the fluid outlets towards the bottom wall 84 and a vacuum is pulled in the fluid inlets to create a vacuum preload type, fluid bearing between the side walls 82 and the bottom wall 84. The vacuum preload type, fluid bearing maintains the bottom wall 84 spaced apart along the Z axis relative to the side walls 82 and allows for motion of the bottom wall 84 along the X axis, the Y axis and about the Z axis relative to the side walls. It should be noted that a vacuum preload fluid bearing can not be utilized if the controlled environment is a vacuum.

Still alternately, the bottom wall 84 can be supported close to the side walls 82 by alternate ways such as magnetic type bearing (not shown).

Referring to FIG. 1, the environmental system 26 controls the environment within the chamber assembly 12 and around the device 32. The desired environment varies accordingly to the device 32 and the design of the rest of the components of the exposure apparatus 10. For example, the desired controlled environment can be an inert gas such as Argon, Helium, or Nitrogen. Alternately, for example, the controlled environment can be a vacuum, or some other fluid.

In the embodiment illustrated in FIG. 1, the environmental system 26 includes a chamber vacuum source 104 and a chamber fluid source 106. The chamber vacuum source 104 and the chamber fluid source 106 are typically coupled via the one or more of the chamber ports 87 to the device chamber 78 formed by the chamber assembly 12. The chamber vacuum source 104 draws the fluid mixture from the device assembly 12 and facilitates the efficient removal of a substantial portion of a first fluid 108 (illustrated as small circles in FIG. 1) from within the device chamber 78. The chamber fluid source 106 provides a second fluid 110 (illustrated as small triangles in FIG. 1) that replaces the fluid mixture that is removed from the chamber assembly 12.

The chamber vacuum source 104 typically includes a vacuum pump. The vacuum pump draws the fluid from the device chamber 78. The vacuum source 104 can also include a vacuum valve 112 and at least one vacuum hose 114. The vacuum valve 112 is positioned in line with the vacuum hose 114. The vacuum hose 114 connects the vacuum pump to the chamber port 87.

The chamber fluid source 106 provides the second fluid 110 used during purging of the device chamber 78. Stated another way, the fluid source 106 directs the second fluid 110 to the device chamber 78 through the one or more chamber ports 87. The design of the chamber fluid source 106 can be varied. The chamber fluid source 106, illustrated in FIG. 1, includes a fluid reservoir 116 and a fluid pump 118 that is in fluid communication with the one or more of the chamber ports 87. The fluid reservoir 116 retains the second fluid 110 and the fluid pump 118 directs the second fluid 110 to the device chamber 78. The fluid source 106 can also include a fluid valve 120 and a fluid hose 122. The fluid valve 120 is positioned in line with the fluid hose 122. The fluid hose 122 couples the fluid reservoir 116 and the fluid pump 118 to the chamber ports 87. Alternately, the pressure in the fluid reservoir 116 can be maintained far higher than that within the device chamber 70, so the pump may not be necessary.

The control system 28 controls the opening and closing of the vacuum valve 112 and the operation of the vacuum pump to remove the necessary amount of the first fluid or other fluids from the device chamber 78. Further, the control system 28 controls the opening and closing of the fluid valve 120 and the operation of the fluid pump 118 to create the desired flow and pressure of the second fluid 110 into the device chamber 78.

The second fluid 110 utilized herein can vary. Preferably, the second fluid 110 is a weakly absorbing gas to minimize absorption of light energy and localized heating within the device chamber 78. Suitable second fluids 110 include inert gases such as helium, argon or neon. Inert gases, as examples, absorb far less radiation than fluids sought to be purged from the device chamber 78 such as oxygen, water, carbon dioxide and other hydrocarbons. Nitrogen may also serve as a purge gas for some radiation source wavelengths.

Preferably, the environmental system 26 also includes a fluid analyzer (not shown) for detecting the composition of fluid in the device chamber 78. The fluid analyzer can discern whether unwanted fluids are present in amounts that may cause undesirable effects. Preferably, the fluid analyzer indicates when the percentage of oxygen, water vapor, carbon dioxide or other hydrocarbons, as examples, is acceptable or excessive. Stated another way, the fluid analyzer can indicate when levels of the first fluid 108 have decreased sufficiently to allow for optimum functioning of the exposure apparatus 10. An acceptable level as provided herein can be approximately less than 10 parts per million (ppm), and preferably approximately less than approximately one ppm, of the first fluid 108. Examples of constituents of the first fluid 108 which can cause undesirable effects include oxygen, water and water vapor, carbon dioxide, and other hydrocarbons. Thus, an acceptable level as provided herein may be approximately single digit, parts per million (ppm) residual oxygen level, residual water level, residual carbon dioxide level, or residual hydrocarbon level, although lower levels of the first fluid 108 can be achieved with the present invention.

Additionally, the environmental system 26 can include one or more cavity pressure monitors for monitoring a cavity pressure within the device chamber 78.

The measurement system 24 monitors the position of the first stage 52, and the second stage 60 relative to the projection optical assembly 20 or some other reference location. With this information, the first stage mover assembly 54 can be used to precisely position the first stage 52 and the second stage mover assembly 62 can be used to precisely position of the second stage 60.

The design of the measurement system 24 can be varied. For example, the measurement system 18 can utilize one or more laser interferometers, encoders, and/or other measuring devices to monitor the position of the stages 52, 60 relative to the projection optical assembly 20. In the embodiment illustrated in FIG. 1, the measurement system 24 includes (i) a first laser interferometer system 124 (illustrated as a block in FIG. 1), and (ii) a second laser interferometer system 126 (illustrated as a block in FIG. 1) that are secured to the projection optical assembly 20. The first interferometer system 124 monitors the position of the first stage 52 relative to the projection optical assembly 20 and the second interferometer system 126 monitors the position of the second stage 60 relative to the projection optical assembly 20.

The control system 28 controls the first stage mover assembly 54 to precisely position the first stage 52, and the second stage mover assembly 62 to precisely position the second stage 60. Additionally, in the embodiment illustrated in the Figures, the control system 28 directs and controls the environmental system 26 to control the environment around the device 32.

The use of the exposure apparatus 10 and the chamber assembly 12 provided herein are not limited to a photolithography system for semiconductor manufacturing. The exposure apparatus 10, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the present invention provided herein can be used in other devices, including other semiconductor processing equipment and inspection machines.

With an exposure device 10 that employs vacuum ultra-violet radiation (VUV) of wavelength 200 nm or lower, use of the catadioptric type optical system can be considered. Examples of the catadioptric type of optical system include the disclosure Japan Patent Application Disclosure No.8-171054 published in the Official Gazette for Laid-Open Patent Applications and its counterpart U.S. Pat. No, 5,668,672, as well as Japan Patent Application Disclosure No.10-20195 and its counterpart U.S. Pat. No. 5,835,275. In these cases, the reflecting optical device can be a catadioptric optical system incorporating a beam splitter and concave mirror. Japan Patent Application Disclosure No.8-334695 published in the Official Gazette for Laid-Open Patent Applications and its counterpart U.S. Pat. No. 5,689,377 as well as Japan Patent Application Disclosure No.10-3039 and its counterpart U.S. patent application Ser. No. 873,605 (Application Date: Jun. 12, 1997) also use a reflecting-refracting type of optical system incorporating a concave mirror, etc., but without a beam splitter, and can also be employed with this invention. As far as is permitted, the disclosures in the above-mentioned U.S. patents, as well as the Japan patent applications published in the Official Gazette for Laid-Open Patent Applications are incorporated herein by reference.

Further, in photolithography systems, when linear motors (see U.S. Pat. No. 5,623,853 or 5,528,118) are used in a wafer stage or a mask stage, the linear motors can be either an air levitation type employing air bearings or a magnetic levitation type using Lorentz force or reactance force. Additionally, the stage could move along a guide, or it could be a guideless type stage that uses no guide. As far as is permitted, the disclosures in U.S. Pat. Nos. 5,623,853 and 5,528,118 are incorporated herein by reference.

Alternatively, one of the stages could be driven by a planar motor, which drives the stage by an electromagnetic force generated by a magnet unit having two-dimensionally arranged magnets and an armature coil unit having two-dimensionally arranged coils in facing positions. With this type of driving system, either the magnet unit or the armature coil unit is connected to the stage and the other unit is mounted on the moving plane side of the stage.

Movement of the stages as described above generates reaction forces that can affect performance of the photolithography system. Reaction forces generated by the wafer (substrate) stage motion can be mechanically released to the floor (ground) by use of a frame member as described in U.S. Pat. No. 5,528,118 and published Japanese Patent Application Disclosure No. 8-136475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. As far as is permitted, the disclosures in U.S. Pat. Nos. 5,528,118 and 5,874,820 and Japanese Patent Application Disclosure No. 8-330224 are incorporated herein by reference.

As described above, a photolithography system according to the above described embodiments can be built by assembling various subsystems, including each element listed in the appended claims, in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, a total adjustment is performed to make sure that accuracy is maintained in the complete photolithography system. Additionally, it is desirable to manufacture an exposure system in a clean room where the temperature and cleanliness are controlled.

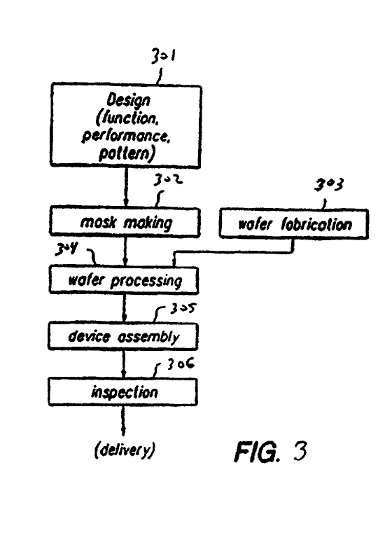

Further, semiconductor devices can be fabricated using the above described systems, by the process shown generally in FIG. 3. In step 301 the device's function and performance characteristics are designed. Next, in step 302, a mask (reticle) having a pattern is designed according to the previous designing step, and in a parallel step 303 a wafer is made from a silicon material. The mask pattern designed in step 302 is exposed onto the wafer from step 303 in step 304 by a photolithography system described hereinabove in accordance with the present invention. In step 305 the semiconductor device is assembled (including the dicing process, bonding process and packaging process), finally, the device is then inspected in step 306.

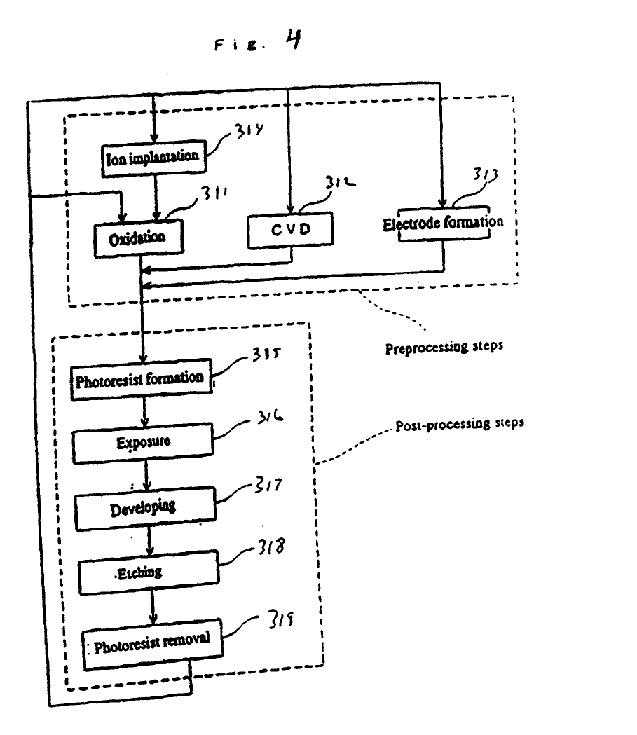

FIG. 4 illustrates a detailed flowchart example of the above-mentioned step 304 in the case of fabricating semiconductor devices. In FIG. 4, in step 311 (oxidation step), the wafer surface is oxidized. In step 312 (CVD step), an insulation film is formed on the wafer surface. In step 313 (electrode formation step), electrodes are formed on the wafer by vapor deposition. In step 314 (ion implantation step), ions are implanted in the wafer. The above mentioned steps 311-314 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 315 (photoresist formation step), photoresist is applied to a wafer. Next, in step 316 (exposure step), the above-mentioned exposure device is used to transfer the circuit pattern of a mask (reticle) to a wafer. Then in step 317 (developing step), the exposed wafer is developed, and in step 318 (etching step), parts other than residual photoresist (exposed material surface) are removed by etching. In step 319 (photoresist removal step), unnecessary photoresist remaining after etching is removed.

Multiple circuit patterns are formed by repetition of these preprocessing and post-processing steps.

Importantly, the design provided herein allows for the use of a smaller chamber assembly 12 to encircle the device 32 and some of the components of the second stage assembly 22 are positioned outside the device chamber 78. As a result thereof, the smaller chamber assembly 12 facilitates faster pump-outs of the device chamber 78 and enhances the access to the components of the exposure apparatus 10 to allow for field servicing and trouble shooting of the components without compromising the controlled environment. Moreover, the components of the second stage assembly 22 that generate dust and debris are positioned outside the device chamber 78 and do not contaminate the controlled environment around the device 30.

While the particular exposure apparatus 10 and the chamber assembly 12 as shown and disclosed herein are fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. An exposure apparatus for transferring an image onto a device, the exposure apparatus comprising:
a stage that retains the device; and
a chamber assembly that encircles the device and provides a device chamber around the device, the chamber assembly including a fixed section, a moving section that moves relative to the fixed section, and a seal assembly that seals an intersection between the fixed section and the moving section during movement of the moving section.

2. The exposure apparatus of claim 1 further comprising a stage mover assembly for moving the stage.

3. The exposure apparatus of claim 2 wherein the moving section moves substantially concurrently with the stage.

4. The exposure apparatus of claim 3 wherein the moving section is secured to the stage.

5. The exposure apparatus of claim 3 wherein the stage includes a device table and the chamber assembly includes a table seal that seals the moving section to the device table.

6. The exposure apparatus of claim 5 wherein the table seal includes bellows that allow for motion to the device table relative to the moving section.

7. The exposure apparatus of claim 2 wherein a portion of the stage mover assembly is positioned outside the device chamber.

8. The exposure apparatus of claim 2 wherein the stage mover assembly is entirely positioned outside the device chamber.

9. The exposure apparatus of claim 1 wherein the fixed section includes a top wall and four side walls and the moving section includes a bottom wall.

10. The exposure apparatus of claim 9 wherein the top wall, the side walls and the bottom wall cooperate to define a substantially rectangular shaped housing.

11. The exposure apparatus of claim 9 wherein the seal assembly seals a bottom edge of the side walls to a top surface of the bottom wall.

12. The exposure apparatus of claim 1 wherein the seal assembly includes a fluid bearing.

13. A device manufactured with the exposure apparatus according to claim 1.

14. A wafer on which an image has been formed by the exposure apparatus of claim 1.

15. An exposure apparatus for transferring an image onto a device, the exposure apparatus comprising:
a stage that retains the device;
a stage mover assembly that moves the stage; and
a chamber assembly that encircles the device and provides a device chamber around the device, the chamber assembly including a moving section that moves substantially concurrently with the stage.

16. The exposure apparatus of claim 15 wherein the moving section is secured to the stage.

17. The exposure apparatus of claim 15 wherein the chamber assembly includes a fixed section and a seal assembly that seals an intersection between the fixed section and the moving section during movement of the moving section.

18. The exposure apparatus of claim 17 wherein the fixed section includes a top wall and four side walls and the moving section includes a bottom wall.

19. The exposure apparatus of claim 18 wherein the top wall, the side walls and the bottom wall cooperate to define a substantially rectangular shaped housing.

20. The exposure apparatus of claim 17 wherein the seal assembly seals a bottom edge of the side walls to a top surface of the bottom wall.

21. The exposure apparatus of claim 15 wherein the stage includes a device table and the chamber assembly includes a table seal that seals the moving section to the device table and allows for motion to the device table relative to the moving section.

22. The exposure apparatus of claim 15 wherein a portion of the stage mover assembly is positioned outside the device chamber.

23. The exposure apparatus of claim 15 wherein the seal assembly includes a fluid bearing.

24. A device manufactured with the exposure apparatus according to claim 15.

25. A wafer on which an image has been formed by the exposure apparatus of claim 15.

26. A method for making a chamber assembly for an exposure apparatus that transfers an image onto a device, the exposure apparatus including a stage that retains the device and a stage mover assembly that moves the stage, the method comprising the steps of:
providing a fixed section;
providing a moving section that moves relative to the fixed section; and
sealing an intersection between the fixed section and the moving section during movement of the moving section with a seal assembly.

27. The method of claim 26 further comprising the step of moving the moving section substantially concurrently with the stage.

28. The method of claim 26 further comprising the step of securing the moving section to the stage.

29. The method of claim 26 further comprising the step of sealing a device table of the stage to the moving section with a table seal, the table seal allowing for motion to the device table relative to the moving section.

30. The method of claim 29 including the step of positioning the moving section above the stage mover assembly.

31. The method of claim 26 wherein the step of providing the fixed section includes providing a top wall and four side walls and the step of providing the moving section includes providing a bottom wall.

32. The method of claim 31 wherein the step of sealing includes the step of sealing a bottom edge of the side walls to a top surface of the bottom wall.

33. A method for making an exposure apparatus including the steps of providing a stage and encircling the stage with a chamber assembly made in accordance with the method of claim 26.

34. A method of making a wafer utilizing an exposure apparatus made by the method of claim 33.

35. A method of making a device including at least the exposure process, wherein the exposure process utilizes the exposure apparatus made by the method of claim 33.

36. A method for making a chamber assembly for an exposure apparatus that transfers an image onto a device, the exposure apparatus including a stage that retains the device and a stage mover assembly that moves the stage, the method comprising the steps of:
providing a fixed section;
providing a moving section that moves relative to the fixed section; and
securing the moving section to the stage.

37. The method of claim 36 further comprising the step of sealing an intersection between the fixed section and the moving section during movement of the moving section with a seal assembly.

38. The method of claim 36 further comprising the step of sealing a device table of the stage to the moving section with a table seal, the table seal allowing for motion to the device table relative to the moving section.

39. The method of claim 36 including the step of positioning the moving section above the stage mover assembly.

40. The method of claim 36 wherein the step of providing the fixed section includes providing a top wall and four side walls and the step of providing the moving section includes providing a bottom wall.

41. The method of claim 40 further comprising the step of sealing a bottom edge of the side walls to a top surface of the bottom wall.

42. A method for making an exposure apparatus including the steps of providing a stage and encircling the stage with a chamber assembly made in accordance with the method of claim 36.

43. A method of making a wafer utilizing an exposure apparatus made by the method of claim 42.

44. A method of making a device including at least the exposure process, wherein the exposure process utilizes the exposure apparatus made by the method of claim 42.
